(19) United States
(12) Patent Application Publication
(10) Pub. No.: US 2025/0371595 A1
(43) Pub. Date: Dec. 4, 2025

(54) Machine Learning Prediction of User Type for Generating Personalized User Interface for an Online System

(71) Applicant: Maplebear Inc., San Francisco, CA (US)

(72) Inventors: Naval Shah, Toronto (CA); Madeline Mesard, New York, NY (US); Brent Scheibelhut, Toronto (CA); Charles Wesley, San Diego, CA (US); Mark Oberemk, Toronto (CA); Akshay Bagai, Toronto (CA)

(21) Appl. No.: 18/676,345

(22) Filed: May 28, 2024

(51) Int. Cl. G06Q 30/0601

(52) U.S. Cl. CPC G06Q 30/0625; G06Q 30/0631; G06Q 30/0641

(57) ABSTRACT

A trained model is used to predict a type of a user of an online system to generate a personalized user interface of the online system. Upon receiving data related to a current session of the user with the online system, the online system applies the trained model to output, based on the session data, a score for the user indicative of a predicted type of the user for the current session. The online system compares the score with a threshold score, and responsive to the score being greater than the threshold score, the online system identifies, based on the score, user data, and information about the current session, a set of user interface elements arranged in a specific order for presentation to the user. The online system then generates a user interface of the device associated with the user that includes the arranged user interface elements.

### BACKGROUND

An online system, such as an online concierge system, allows users to place orders via user interfaces. Different types of users have different ways to interact with online systems to find items. For example, some users prefer to go right to purchasing an intended item. Those are users who typically focus on a specific type of item they need to purchase, search for this particular item type, and pick one or more items for purchase. These users may perform limited amounts of browsing towards identifying and purchasing items, but primarily they focus on gathering the items they need. Users of this particular type can be referred to as “searchers.” Other users are more into discovery and exploration of content offered by an online system. Those are users who typically rely heavily on browsing, i.e., they may browse many item categories or collections, view a lot of items, and look into their details (images, descriptions, etc.). Users of this particular type are also generally open to exploring new types of items and exploring new aisles they have not seen as they desire to find something new that they might like. Users of this particular type can be referred to as “browsers.”

However, a user interface on an online system treats different types of users in the same manner, which leads to an inefficient user interface for one or both types of users.

### SUMMARY

Embodiments of the present disclosure are directed to using a trained machine-learning model of an online system (e.g., online concierge system) to predict a type of a user of the online system to generate a personalized user interface of the online system that is specific for the predicted user's type.

In accordance with one or more aspects of the disclosure, the online system receives, from a device associated with a user of the online system and via a network, session data related to a current session of the user with the online system. The online system accesses a user type prediction model of the online system, wherein the user type prediction model is trained to predict a type of the user for the current session. The online system applies the user type prediction model to output, based at least in part on the session data, a score for the user indicative of the predicted type of the user for the current session. The online system compares the score for the user with a threshold score. Responsive to the score for the user being greater than the threshold score, the online system identifies, based at least in part on the score for the user, user data associated with the user, and information about the current session, a set of user interface elements arranged in a specific order for presentation to the user. The online system generates a user interface of the device associated with the user that includes the set of user interface elements arranged according to the specific order. The online system causes the device associated with the user to display the user interface with the set of user interface elements arranged according to the specific order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example smart shopping cart associated with an online concierge system, in accordance with one or more embodiments.

FIG. 4 illustrates an example architectural flow diagram of using a trained model of an online concierge system to predict a type of a user of the online concierge system to generate a personalized user interface of the online concierge system that is specific for the predicted user's type, in accordance with one or more embodiments.

FIG. 5A illustrates an example user interface of a device associated with a user of an online concierge system that is adjusted based on a predicted user's type, in accordance with one or more embodiments.

FIG. 5B illustrates another example user interface of a device associated with a user of an online concierge system that is adjusted based on a predicted user's type, in accordance with one or more embodiments.

FIG. 6 is a flowchart for a method of using a trained model of an online concierge system to predict a type of a user of the online concierge system to generate a personalized user interface of the online concierge system that is specific for the predicted user's type, in accordance with one or more embodiments.

### DETAILED DESCRIPTION

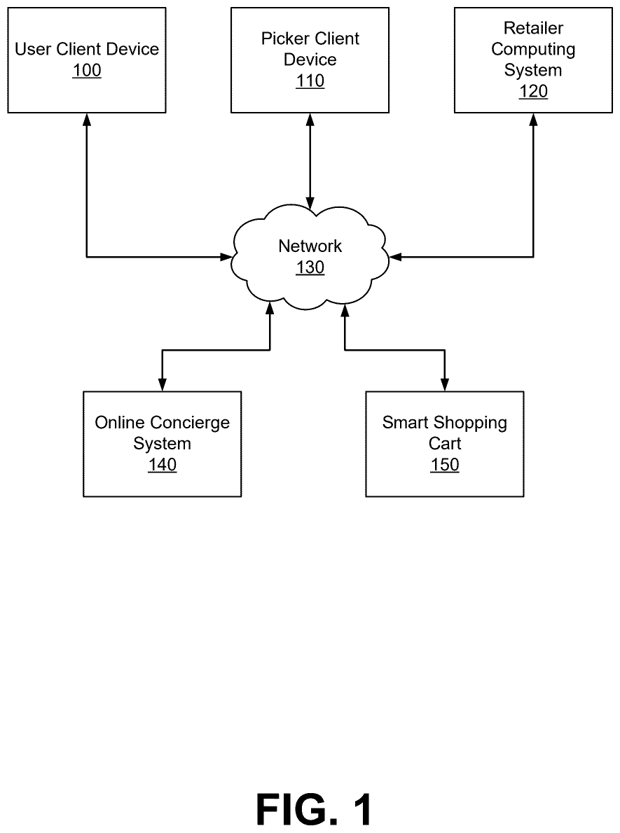

FIG. 1 illustrates an example system environment for an online concierge system 140, in accordance with one or more embodiments. The system environment illustrated in FIG. 1 includes a user client device 100, a picker client device 110, a retailer computing system 120, a network 130, an online concierge system 140, and a smart shopping cart 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 provides an interface for users to search or browse for items in an online database maintained by the online concierge system 140. The online concierge system 140 presented herein trains a classifier model (e.g., machine-learning model) that classifies users of the online concierge system 140. In particular, the classifier model may be trained to predict whether a user is a “browser” who likes to explore content from the online database when displayed at a user interface, as opposed to a “searcher” who prefers to go right to locating and purchasing an item they need. When a particular user interacts with the online concierge system 140, the online concierge system 140 applies the trained classifier model to determine whether that specific user is a “browser.” Based on the determination of user's type, if the user is a “browser”, the online concierge system 140 presents content that tends to allow the user to explore, e.g., content ranked by the user's preferences. In contrast, if the user is not a “browser”, the online concierge system 140 directs the user to the user's present intent, e.g., content ranked by a search query entered by the user.

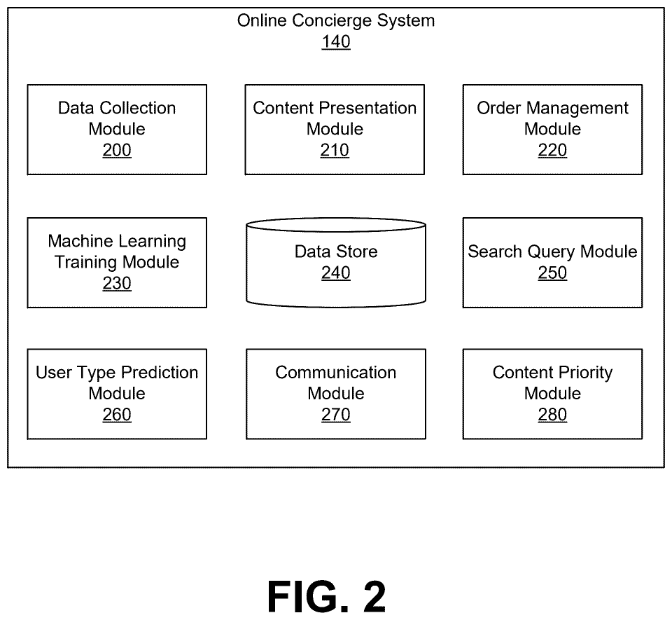

The online concierge system 140 presented herein may further utilize a priority model (e.g., machine-learning model) that is trained to identify the specific priority of different content (e.g., item categories, predefined collections, aisles, etc.) for a particular user to browse. In this manner, a user interface of the online concierge system 140 is personalized for a particular user. To present the user with additional content to browse, the priority model may decide what content elements (e.g., items, category of items) to present to the user. The priority model may find items that are adjacent (e.g., supplemental, complementary, etc.) to the items for which the user has an express intent. And the priority model may exclude content that the user has already looked at during the session (whether viewed online or walked past an aisle when purchasing in-store using the smart shopping cart 150). The online concierge system 140 is described in further detail below with regards to FIG. 2.

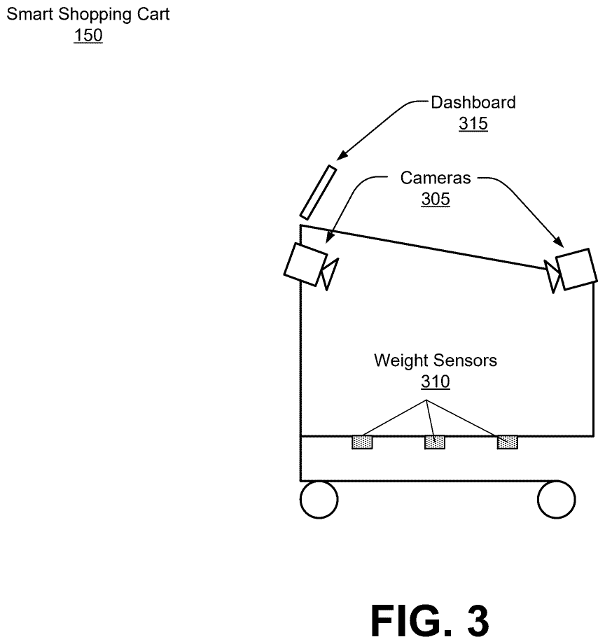

The smart shopping cart 150 is an in-store shopping cart that enables a user of the online concierge system 140 to physically add (i.e., place) items from a location of a retailer (e.g., store) into the smart shopping cart 150 and check the items out from the location of the retailer without an involvement of an employee of the retailer at the point of sale. The smart shopping cart 150 may be connected to the online concierge system 140 via the network 130. During the user's shopping session, the smart shopping cart 150 may utilize various sensors (e.g., one or more weight sensors, one or more cameras, etc.) to gather data about the user's activity, including, but not limited to, a location of the smart shopping cart 150 in the store, weight changes of the smart shopping cart 150 as items are added to or removed from the smart shopping cart 150, video of the user's activity in and around the smart shopping cart 150, video of shelfs with items in the store, etc. In one or more embodiments, the smart shopping cart 150 is considered being a part of the online concierge system 140. It should be noted that the concepts described herein in relation to the smart shopping cart 150 can be extended and/or applied to other form factors, such as a handheld shopping basket, a handheld receptacle, or some other handheld object that can be used to receive and store shopping items. The smart shopping cart 150 is described in further detail below with regards to FIG. 3.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a search query module 250, a user type prediction module 260, a communication module 270, and a content priority module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The search query module 250 may receive a search query entered by a user of the online concierge system 140 via a search interface of the user client device 100. The search query module 250 may receive the search query from the user client device 100 via the network 130. The search query module 250 may receive the search query that is entered by the user at a start of a user's current session at the online concierge system 140. The search query module 250 may provide the received search query to the user type prediction module 260, and the received search query may be used as one of input features for a user type prediction model (e.g., machine-learning model). The search query module 250 may also retrieve, based on the received search query, a set of items or item categories from the data store 240 that may be potentially presented to the user.

The user type prediction module 260 may access a user type prediction model (e.g., machine-learning model) that is trained to predict a type of the user for the current session. The user type prediction module 260 may deploy the user type prediction model to run a machine-learning algorithm to output, based on a set of inputs, a score for the user indicative of the predicted type of the user for the current session. In one or more embodiments, the user type prediction model is implemented as a classifier-based machine-learning model that classifies a user based on user's traits independent of any retailer associated with the online concierge system 140. Alternatively, the user type prediction model may be a classifier-based machine-learning model that classifies a user for a specific retailer associated with the online concierge system 140. In such cases, the user type prediction model may output the score for a specific user-retailer pair. A set of parameters for the user type prediction model may be stored at one or more non-transitory computer-readable media of the user type prediction module 260. Alternatively, the set of parameters for the user type prediction model may be stored at one or more non-transitory computer-readable media of the data store 240.

In particular, the user type prediction model may output the score for the user that is indicative of a likelihood that the user is a “browser.” The score for the user output by the user type prediction model may essentially represent how much of a “browser” the user is. The score for the user may be between 0 and 1, where a higher value of the score for the user may indicate a higher likelihood that the user is a “browser.” Hence, a higher value of the score for the user may indicate that the user is amenable to having a longer shopping experience where the user can be presented with more items or aisles than strictly what is on their shopping list (if any).

The user type prediction module 260 may provide the set of inputs representing various input features to the user type prediction model that are suitable for predicting a type of the user for the current session. In providing the set of inputs to the user type prediction model, the user type prediction module 260 may provide online session data related to the user's online interaction with the online concierge system 140 during the current session. In providing the online session data to the user type prediction model, the user type prediction module 260 may provide: the search query entered by the user, a number of different predefined collections (e.g., produce, dairy and eggs, beverages, etc.) the user has engaged with during the current session, a ratio between a number of unique items the user has viewed during the current session (e.g., number of product detailed pages (PDPs) loaded during the current session) and a number of items the user actually added to a cart, a percentage of items the user has added to the cart without viewing the actual PDP (e.g., items added to the cart from just the search results), information about a retailer associated with the current session, some other online session-related data, or some combination thereof. The online concierge system 140 may receive (e.g., via the search query module 250 and/or the user type prediction module 260) the online session data from the user client device 100 via the network 130.

In providing the set of inputs to the user type prediction model, the user type prediction module 260 may further provide user's historical purchase data. In providing the user's historical purchase data to the user type prediction model, the user type prediction module 260 may provide: a percentage of items in the user's historical orders that came from direct search followed by add-to-cart actions, a percentage of items in the user's historical orders that were added to carts via browsing, an average shopping time per item, information on when each item was added to a cart relative to each other item in a particular order, some other user's historical purchase data, or some combination thereof. The user type prediction module 260 may compute the average shopping time per item as a total duration of the cart-building phase for each historical order divided by a number of unique items in the cart. In computing the average shopping time per item, the user type prediction module 260 may exclude a portion of the extreme ends of the spectrum (e.g., the quickest items or longest items) and primarily focus on the median for the primary shopping ‘trip’ (when the user added most of the items). For the information on when each item was added to the cart relative to other items in the order, it may happen that a user quickly added a few items earlier in the week but then the user came back later to do the bulk of their cart shopping. Hence, the user type prediction module 260 may weigh the earlier added items less, because the earlier added items are not typically indicative of the user's overall browser score. The user type prediction module 260 may retrieve the user's historical purchase data from, e.g., the data store 240.

In providing the set of inputs to the user type prediction model, the user type prediction module 260 may further provide in-store data related to the current session. In providing the in-store data to the user type prediction model, the user type prediction module 260 may provide data related to an in-store mode of an application of the online concierge system 140 running on the user client device 100, data collected by one or more sensors of the smart shopping cart 150 utilized by the user during the current session for shopping at a location of a retailer associated with the online concierge system 140, some other in-store data, or some combination thereof. The user type prediction module 260 may receive the data related to the in-store mode of the application from the user client device 100 over the network 130.

Alternatively or additionally, the communication module 270 may receive the in-store data from the smart shopping cart 150 via the network 130. The communication module 270 may then provide at least a portion of the received in-store data to the user type prediction module 260 or directly to the user type prediction model.

FIG. 3 illustrates an example smart shopping cart 150 associated with the online concierge system 140, in accordance with one or more embodiments. The smart shopping cart 150 may have one or more cameras 305 that collect video data and/or image data in relation to shelfs (i.e., store aisles) with various stored items as a user that utilizes the smart shopping cart 150 for in-store shopping is passing by. The one or more cameras 305 may further collect video data and/or image data in relation to items placed in the smart shopping cart 150, such as a weight of each item as indicated in an item label, a brand of each item, a price of each item, etc. Additionally, the one or more cameras 305 may collect video data and/or image data in relation to actions in and around the smart shopping cart 150, such as a location of the smart shopping cart 150 in a store (e.g., location of the retailer) when a certain action occurs (e.g., when an item is added to the cart), user's gestures when placing items in the smart shopping cart 150, video and/or images of user's interactions with the smart shopping cart 150, track the location of the user within the store, measure a velocity of the smart shopping cart 150 in the store, etc. Alternatively or additionally, the smart shopping cart 150 may be equipped with one or more weight sensors 310 that measure weights of items placed in the smart shopping cart 150. The smart shopping cart 150 may further include a dashboard 315 that operates as a user interface that displays a list of items added to a receptacle of the smart shopping cart 150 and can be used for the checkout. The smart shopping cart 150 may include additional sensors not shown in FIG. 3. The dashboard 315 or some other component of the smart shopping cart 150 may further include a computing system that is in communication with the user client device 100, the retailer computing system 120 and/or the online concierge system 140 via the network 130. Data gathered by various sensors of the smart shopping cart 150 may be uploaded via the network 130 to the communication module 270 and provided as inputs to the user type prediction model.

In providing the in-store data to the user type prediction model, the user type prediction module 260 (and/or the communication module 270) may provide data related to an average duration of a shopping trip, a number of items the user scanned with the application of the online concierge system 140 or via the smart shopping cart 150, an average speed of the movement of the smart shopping cart 150 for the shopping trip (where slower cart velocity is indicative of a higher likelihood that the user is a “browser”), an average distance the smart shopping cart 150 traveled per unique item added to the smart shopping cart 150, some other in-store data, or some combination thereof. Note that the user type prediction module 260 or the communication module 270 may calculate the average duration of the shopping trip from data gathered by the sensors of the smart shopping cart 150 or from data collected using the in-store mode of the application of the online concierge system 140. The higher the average duration of the shopping trip is, the more of a “browser” the user is. Additionally or alternatively, to compute the average distance the smart shopping cart 150 traveled per unique item, the communication module 270 may calculate a ratio between a total distance traveled by the smart shopping cart 150 and a number of unique items in the smart shopping cart 150. The higher the distance the smart shopping cart 150 traveled per unique item is, the more of a “browser” the user is.

The content priority module 280 may prioritize, based on the score for the user output by the user type prediction model, historical user data, and data related to the user's current session, content for presentation to the user, e.g., via a user interface of the user client device 100 or the dashboard 315 of the smart shopping cart 150. In one or more embodiments, the content priority module 280 ranks, based on the score for the user, the user data, and the data related to the user's current session, content (e.g., items, item collections, item categories, etc.) retrieved from the data store 240 to identify a rank of each individual content element (e.g., item, item collection, item category, etc.). A content element that is ranked for presentation at the user interface can be also referred to herein as a user interface element.

In one or more other embodiments, the content priority module 280 accesses a content priority model (e.g., machine-learning model) that is trained to identify a priority of a content element for presentation to the user. The content priority module 280 may deploy the content priority model to run a machine-learning algorithm to output, based on the score for the user, the user data, and the data related to the user's current session, a rank for each content element that is indicative of a priority of that content element for presentation to the user. The content priority model may be implemented as a ranking machine-learning model. A set of parameters for the content priority model may be stored at one or more non-transitory computer-readable media of the content priority module 280. Alternatively, the set of parameters for the content priority model may be stored at one or more non-transitory computer-readable media of the data store 240. In one or more embodiments, the content priority module 280 and the content priority model are part of the content presentation module 210.

After the content elements are ranked (e.g., either by the content priority module 280 or the content priority model), the content priority module 280 may select, based on the rank of each content element, a set of one or more content elements for presentation to the user. The content priority module 280 may further arrange, based on the rank of each content element, the set of content elements in a specific order for presentation to the user. For example, when the user type prediction model identifies that the user is a “browser” and in response to a search query entered by the user via a search interface of the user client device 100, the content priority module 280 or the content priority model may up-rank search results (i.e., content elements) that are more relevant to the user's preferences and less relevant to the specific search query. In contrast, when the user type prediction model identifies that the user is not a “browser”, the content priority module 280 or the content priority model may up-rank search results (i.e., content elements) that are directly relevant to the search query and down-rank content elements (e.g., items) that are merely relevant to the user's preferences.

In particular, the content priority model may determine a prioritized list of aisles (or predefined collections) for presentation to the user. If the user is more of a “browser” as being represented by the score for the user output by the user type prediction model that is higher than a threshold score, then the online concierge system 140 has an opportunity to show items from one additional aisle (or one additional item collection) to the user who is identified as a “browser”. In such cases, the content priority model may determine which aisle (or item collection) should be chosen for presentation to the user given the user's order history, the current (active) cart content, and/or content of the user's in-store shopping list. For example, if the user has already added all of their produce items to the cart, the online concierge system 140 would not continue showing them more produce items, and instead would show non-produce content. Similarly, if the user has dairy and eggs items on the in-store shopping list but has not yet added these items to the cart, the online concierge system 140 would not show items from that item category, and instead would show items from some other item category that the user may not browse during the current session.

In providing the historical user data to the content priority model, the content priority module 280 may provide information about the user's order history, information about adjacent categories and affinities between categories of items, some other order related data, or some combination thereof. For the user's order history, each order has a set of items that belongs to different taxonomy categories or predefined aisles. The content priority module 280 may retrieve this information from, e.g., the data store 240, and the content priority model may then utilize the retrieved information to build a set of item categories that the user has purchased from. Furthermore, the content priority module 280 may access a global set of transaction history (e.g., via an application programming interface (API)), and the content priority model may use the transaction history to identify affinity between different categories (e.g., whether a user who purchases prepared foods is more likely to purchase frozen foods). Based on this information, the content priority model may facilitate guiding the user to explore an additional category of items that is most likely to be one they may enjoy browsing.

In providing the data related to the user's current session to the content priority model, the content priority module 280 may provide content of the current cart, a current session browsing history, a current in-store shopping list, in-store shopping session data gathered by sensors of the smart shopping cart 150, some other data related to the current shopping session, or some combination thereof. The content of the current cart may include details about items added to the user's cart during the current shopping session, e.g., either to the online user's cart or to the smart shopping cart 150. The current session browsing history may include details of items that the user has already seen or scrolled past during the current shopping session. For example, if the user has already viewed a number of items (e.g., the user has scrolled online through a bunch of produce) and added none to the cart, the content priority model may weigh that category/aisle lower. Alternatively, information about the current session browsing history may originate from an in-store purchase using the smart shopping cart 150, and may correspond to information gathered by the cameras 305 of the smart shopping cart that the user has already slowly travelled through specific aisles (e.g., the produce aisles). The in-store shopping list may be related to in-store mode's shopping list, online shopping list, or shopping list functionality on the dashboard 315 of the smart shopping cart 150. The content priority model may then exclude categories that the user would naturally encounter during the current shopping trip and instead focus on categories that they have not yet explored and/or were not planning to explore. The content priority module 280 may receive the data related to the user's current session from the user client device 100 via the network 130 and/or from the smart shopping cart 150 via the network 130.

The content presentation module 210 may receive, from the content priority module 280, information about the prioritized content with content elements (i.e., user interface elements, such as items or collection of items) arranged in a specific order according to their ranks. Based on the received information, the content presentation module 210 may cause the user client device 100 to display the user interface with the content elements (i.e., user interface elements) arranged in the specific ranked order. For example, if the user type prediction model identifies that a user is a “browser”, the content presentation module 210 may generate the user interface with additional “discovery” flows (e.g., upsells, additional ads, etc.) so that the user can have additional browsing experience when interacting with the user interface. Additionally or alternatively, the content presentation module 210 may generate the appropriate content at the dashboard 315 of the smart shopping cart 150 so that the user with the smart shopping cart 150 can make more detours at the store if the user is a “browser.”

The machine-learning training module 230 may perform initial training of the user type prediction model using training data. The machine-learning training module 230 may generate the training data by gathering, over a defined time period (e.g., 24 hours, week, two weeks, etc.), data related to interactions between a collection of users of the online concierge system 140 and the online concierge system 140 (e.g., whether fully online or in-store using smart shopping carts 150 and/or in-store mode of an application of the online concierge system 140). The machine-learning training module 230 may then assign, based on the gathered data, a label to each user in the collection of users, i.e., each user is labeled as a “browser” or a “searcher.” For example, the machine-learning training module 230 may apply a set of heuristics to label users based on their historical interactions with the online concierge system 140. Finally, the machine-learning training module 230 may train the user type prediction model using the training data including the gathered data and the assigned label for each user in the collection of users, to generate initial values for the set of parameters of the user type prediction model.

The machine-learning training module 230 may further collect feedback data with information about engagement by the user with content elements displayed at the user interface of the user client device. Alternatively or additionally, the machine-learning training module 230 may collect feedback data with information about the user's in-store responses to the generated user interface at the dashboard 315 of the smart shopping cart 150. The machine-learning training module 230 may re-train the user type prediction model by updating, using the collected feedback data, the set of parameters of the user type prediction model. Additionally, the machine-learning training module 230 may re-train the content priority model by updating, using the collected feedback data, the set of parameters of the content priority model.

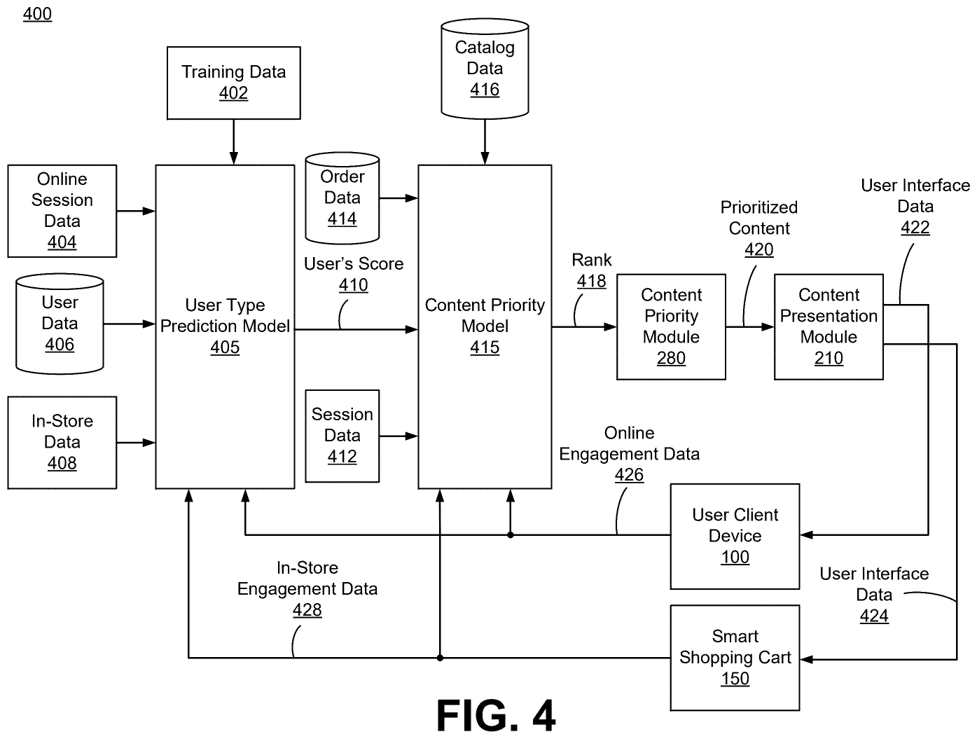

FIG. 4 illustrates an example architectural flow diagram 400 of using a user type prediction model 405 to predict a type of a user of the online concierge system 140 to generate a user interface of the online concierge system 140 that is specific for the predicted user's type, in accordance with one or more embodiments. First, the online concierge system 140 may perform (e.g., via the machine-learning training module 230) initial training of the user type prediction model 405 using training data 402 to generate initial values for the set of parameters of the user type prediction model 405. The training data 402 may be generated (e.g., via the machine-learning training module 230) by gathering, over a defined time period, data related to historical interactions between a collection of users of the online concierge system 140 and the online concierge system 140 and assigning, based on the gathered data, a label to each user in the collection of users (e.g., labeling each user as a “browser” or a “searcher”). After the training process is completed, the online concierge system 140 may provide various inputs to the user type prediction model 405 (e.g., via the user type prediction module 260 and/or the search query module 250), such as online session data 404, user data 406, and/or in-store data 408. Some additional input features not shown in FIG. 4 suitable for predicting a type of a user may be further provided to the user type prediction model 405.

In providing the online session data 404 to the user type prediction model 405, the online concierge system 140 may provide (e.g., via the user type prediction module 260 and/or the search query module 250) a search query entered by the user, a number of different predefined collections (e.g., produce, dairy and eggs, beverages, etc.) the user has engaged with during a current shopping session, a ratio between a number of unique items the user has viewed during the current session and a number of items the user actually added to a cart, a percentage of items the user has added to the cart without viewing their details, information about a retailer associated with the current shopping session, some other online session data, or some combination thereof. The online concierge system 140 may receive the online session data 404 from the user client device 100 via the network 130.

In providing the user data 406 to the user type prediction model 405, the online concierge system 140 may provide (e.g., via the user type prediction module 260) a percentage of items in the user's historical orders that came from direct searches, a percentage of items in the user's historical orders that were added to carts via browsing, an average shopping time per item, information on when each item was added to a cart relative to other items in a particular order, some other user's historical purchase data, or some combination thereof. The delivery prediction module 260 may retrieve at least a portion of the user data 406 from the data store 240 and compute some portions of the user data 406 from information retrieved from the data store 240.

In providing the in-store data 408 to the user type prediction model 405, the online concierge system 140 may provide (e.g., via the user type prediction module 260 and/or the communication module 270) data related to an average duration of a shopping trip, a number of items the user scanned with the application of the online concierge system 140 or via the smart shopping cart 150, an average speed of the smart shopping cart 150 movement for the shopping trip, an average distance the smart shopping cart 150 traveled per unique item added to the smart shopping cart 150, some other in-store data, or some combination thereof. The online concierge system 140 may receive the in-store data 408 from the user client device 100 and/or the smart shopping cart 150 via the network 130.

The user type prediction model 405 may apply a classification-based machine-learning algorithm to the online session data 404, the user data 406, and/or the in-store data 408 to output a user's score 410 that is indicative of a likelihood that the user is a “browser.” The user's score 410 may be a value between 0 and 1, where a higher value of the user's score 410 may indicate a higher likelihood that the user is a “browser.” In one or more embodiments, the user's score 410 is indicative of a likelihood that the user is a “browser” for a specific retailer associated with the online concierge system 140. The user's score 410 output by the user type prediction model 405 may be passed to a content priority model 415. In addition to the user's score 410, the online concierge system 140 may provide various other inputs to the content priority model 415, such as session data 412, order data 414, and/or catalog data 416. Some additional input features not shown in FIG. 4 suitable for predicting a rank of a content element for presentation to the user may be further provided to the content priority model 405.

In providing the session data 412 to the content priority model 415, the online concierge system 140 may provide information about content of a current cart, a current session browsing history, a current in-store shopping list, in-store shopping session data gathered by sensors of the smart shopping cart 150, some other data related to the current shopping session, or some combination thereof. The online concierge system 140 may receive the session data 412 from the user client device 100 and/or the smart shopping cart 150 via the network 130. In providing the order data 414 to the content priority model 415, the online concierge system 140 may provide information about the user's order history, information about adjacent categories and affinities between categories of items, some other order data, or some combination thereof. The order data 414 may be retrieved from the data store 240 or some other online sources accessed via an API. Additionally, the content priority model 415 may have access to catalog data 416 (e.g., from the data store 240) that includes content suitable for presentation to the user, e.g., a pre-determined list of item categories and/or items preferred by the user.

The content priority model 415 may apply a ranking-based machine-learning algorithm to the user's score 410, the session data 412, the order data 414, and/or the catalog data 416 to output a rank 418 for each content element (i.e., user interface element, such as collection of items, individual items, etc.) from the catalog data 416, wherein the rank 416 is indicative of a priority of that content element for presentation at a user interface of the online concierge system 140. The rank 418 for each content element may be passed to the content priority module 280. The content priority module 280 may then select, based on the rank 418, a set of content elements for presentation to the user and arrange, based on their ranks 418, the selected set of content elements in a specific order for display at the user interface. The content priority module 280 may output the arranged set of content elements as prioritized content 420 that is then passed to the content presentation module 210.

The content presentation module 210 may use the prioritized content 420 to generate user interface data 422 and/or user interface data 424. The content presentation module 210 may cause, based on the user interface data 422, a user interface of the user client device 100 to display user interface elements of the prioritized content 420 (e.g., item categories, individual items, notifications, prompting messages, etc.) in the arranged order. Similarly, the content presentation module 210 may cause, based on the user interface data 424, the dashboard 315 of the smart shopping cart 150 to display user interface elements of the prioritized content 420 (e.g., item categories, individual items, notifications, prompting messages, etc.) in the arranged order.

Upon generating the user interface at the user client device 100, the user client device 100 may generate online engagement data 426 with information about the user's engagement with the user interface elements displayed at the user interface of the user client device 100. The online engagement data 426 may include information about the user's conversion of one or more items, information about the user's browsing through displayed content, information about the user's response to any notifications/messages displayed at the user interface, some other online feedback information from the user, or some combination thereof. The online concierge system 140 may receive (e.g., via the machine-learning training module 230) the online engagement data 426 from the user client device 100 via the network 130. The machine-learning training module 230 may utilize the online engagement data 426 to re-train the user type prediction model 405 and/or the content priority model 415. By utilizing the online engagement data 426, the machine-learning training module 230 may update the set of parameters of the user type prediction model 405 and/or the set of parameters of the content priority model 415, and continuously improve the machine-learning algorithm of the user type prediction model 405 and/or the machine-learning algorithm of the content priority model 415.

Similarly, upon generating the user interface at the dashboard 315 of the smart shopping cart 150, the computing system of the smart shopping cart 150 may generate in-store engagement data 428 with information about the user's engagement while conducting in-store shopping by utilizing the smart shopping cart 150 in response to the user interface elements displayed at the dashboard 315. The in-store engagement data 428 may include information about the one or more items scanned via the smart shopping cart 150 in response to the generated user interface, information about a movement of the smart shopping cart 150 through the store in response to the generated user interface, some other in-store feedback information, or some combination thereof. The online concierge system 140 may receive (e.g., via the machine-learning training module 230) the in-store engagement data 428 from the smart shopping cart 150 via the network 130. The machine-learning training module 230 may utilize the in-store engagement data 428 to re-train the user type prediction model 405 and/or the content priority model 415. By utilizing the in-store engagement data 428, the machine-learning training module 230 may update the set of parameters of the user type prediction model 405 and/or the set of parameters of the content priority model 415, and continuously improve the machine-learning algorithm of the user type prediction model 405 and/or the machine-learning algorithm of the content priority model 415.

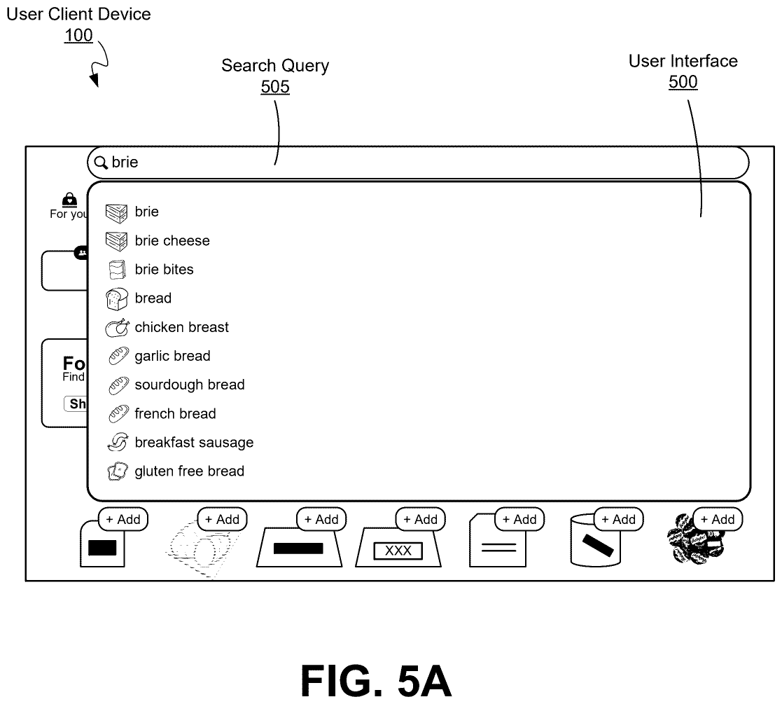

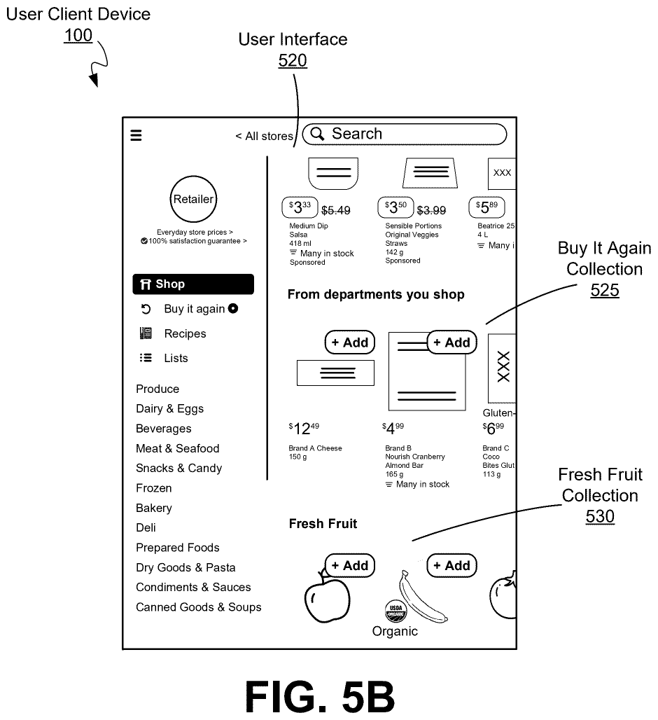

FIG. 5A illustrates an example user interface 500 of the user client device 100 that is adjusted based on a predicted user's type, in accordance with one or more embodiments. The content presentation module 210 may cause the user client device 100 to display the user interface 500 during a user's session (e.g., before the checkout) while the user searches for specific items or item categories. In this illustrative embodiment, the online shopping search relevancy is adjusted based on a predicted type of the user. When the user issues a search query 505 (e.g., “brie”), the user type prediction model (as well as the content priority model) may facilitate the adjustment of search relevancy for this specific user. For example, if the user type prediction model predicts that the user is primarily a “browser”, the online concierge system 140 may lower the relevancy of certain search results directly related to the search query 505 and effectively adjust the search results (e.g., via the content priority model) so that the user interface 500 displays a mix of what the user is actually searching for (e.g., “brie”, “brie cheese”, “brie bites”) combined with other items from categories identified as being of interest for this specific user or return results that include other adjacent categories (e.g., “bread”, “chicken breast”, etc.). This would facilitate adding more “browsing” into the user's otherwise “normal” shopping journey.

Additionally or alternatively, the content presentation module 210 may receive a prioritized list of items from the content priority module 280 for displaying at the user interface 500 that represents adjusted autocomplete results for the search query 505. For example, if a user is searching for a “brie”, the content presentation module 210 may cause the user interface 500 to display a few high relevancy search results, followed by prompts to either explore another category (e.g., “Take a look at these new cured meats”) or follow a guided experience (e.g., “Put together a charcuterie board?”).

FIG. 5B illustrates another user interface 520 of the user client device 100 that is adjusted based on a predicted user's type, in accordance with one or more embodiments. The content presentation module 210 may cause the user client device 100 to display a specific page of the user interface 520, e.g., a user's home page or some other browsing-heavy pages. In this manner, the user interface 520 is adjusted to show “discover” shopping flows or upsell flows to a specific user. Once the user is identified as a “browser”, the content presentation module 210 may adjust the user interface 520 to prompt the user to explore certain prioritized collections. For example, the user interface 520 shows a Buy It Again collection 525 that is prominently featured, which is followed by a Fresh Fruit collection 530. The online concierge system 140 presented herein may adjust the weights for the categories that the user interface 520 displays, which can be dynamically changed as the user shops.

In one or more embodiments, the online concierge system 140 presented herein adjusts a load of ads based on a predicted user's type. In such cases, the score for the user output by the user type prediction model may feed into an ad serving platform (e.g., part of the data collection module 200) as one of the inputs the ad serving platform can use to adjust how the online concierge system 140 displays and chooses ads for the user. For example, users with a high browser score may have a higher capacity to view ads, and higher capacity to view ads that are tangential to what the users are immediately shopping for. These users may be more open to ads for new brands or items, and may also need to see more ads before they would be considered saturated by ads.

In one or more embodiments, when a user identified as a “browser” is using the smart shopping cart 150 for in-store shopping, the online concierge system 140 presented herein can route the user strategically through aisles so that the user is exposed to more categories of items with the hopes that the user would see something they want to buy, or trigger a whole category of items they have not yet shopped for during this shopping trip. For example, the online concierge system 140 may appropriately adjust a user interface of the dashboard 315 to route the user through the frozen dessert aisle in order to prompt the user to take a closer look and add, e.g., ice cream or another frozen treat to the smart shopping cart 150. Similarly, by appropriately adjusting a user interface of the dashboard 315, the user that uses the smart shopping cart 150 can be routed through the fruits and vegetables area of the store that may spark interest in looking at new types of vegetables or seasonal fruits they have not seen yet.

In one or more embodiments, if an in-store user is routing between items on a user's shopping list of an in-store mode of an application of the online concierge system 140 running on the user client device 100, the online concierge system 140 may generate a user interface of the user client device 100 to add an intermediate destination between two items in the shopping list. For example, the online concierge system 140 may generate the user interface to show the following prompts: “Stop off at the frozen desserts aisle on your way to pick up your milk! There's a new brand of local ice cream that you might like to see. It will add 1 minute to your shopping time”.

Note that the types of nudges may differ depending on the browser score of the user. For users with a low browser score, the nudges may focus on ensuring the users have visited aisles for which there is a high certainty that they missed or will purchase something from. For users with a high browser score, the nudges would be more exploratory and instead appeal to users' nature to see and feel new types of items. For example, the online concierge system 140 can generate a user interface with a “guided path”, such as, “Want to create an ice cream sundae? Click here to follow this route.”

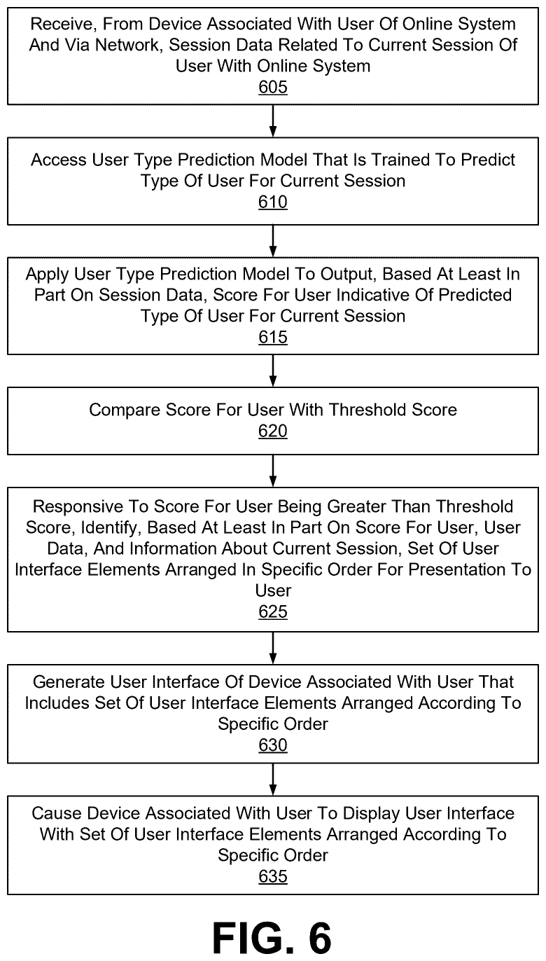

FIG. 6 is a flowchart for a method of using a trained model of an online concierge system to predict a type of a user of the online concierge system to generate a personalized user interface of the online concierge system that is specific for the predicted user's type, in accordance with one or more embodiments. Alternative embodiments may include more, fewer, or different steps from those illustrated in FIG. 6, and the steps may be performed in a different order from that illustrated in FIG. 6. These steps may be performed by an online concierge system (e.g., the online concierge system 140). Additionally, each of these steps may be performed automatically by the online concierge system without human intervention.

The online concierge system 140 receives 605 (e.g., at the search query module 250, the user type prediction module 260 and/or the communication module 270), from a device associated with a user of the online concierge system 140 (e.g., the user client device 100 or the smart shopping cart 150) and via a network (e.g., the network 130), session data related to a current session of the user with the online concierge system 140. In one or more embodiments, the online concierge system 140 receives the session data by receiving (e.g., at the search query module 250, the user type prediction module 260 and/or the communication module 270), via the device associated with the user and via the network, at least one of: a search query entered by the user via a search interface of the device associated with the user, a number of predefined collections of items the user engaged with during the current session, a ratio between a number of unique first items the user engaged with during the current session and a total number of unique items the user added to a cart during the current session, a ratio between a number of unique second items added to the cart without the user viewing details associated with the second items and the total number of unique items added to the cart, or a timestamp of each unique item added to the cart.

In one or more other embodiments, the online concierge system 140 gathers, via one or more sensors (e.g., the cameras 305 and/or the weight sensors 310) mounted to a physical receptacle (e.g., the smart shopping cart 150) utilized by the user during the current session for shopping at a location of a retailer associated with the online concierge system 140, data with information about at least one of: a duration of the current session at the location of the retailer, a number of items scanned by a computing system associated with the physical receptacle during the current session, an average speed of movement of the physical receptacle during the current session, or an average distance traveled by the physical receptacle during the current session per item added to the physical receptacle. In such cases, the online concierge system 140 may receive (e.g., at the communication module 270), from the computing system associated with the physical receptacle and via the network, the gathered data as at least a portion of the session data.

The online concierge system 140 accesses 610 a user type prediction model of the online concierge system 140 (e.g., via the user type prediction module 260), wherein the user type prediction model is trained to predict a type of the user for the current session. The online concierge system 140 applies 615 (e.g., via the user type prediction module 260) the user type prediction model to output, based at least in part on the session data, a score for the user indicative of the predicted type of the user for the current session. The online concierge system 140 may apply the user type prediction model (e.g., via the user type prediction module 260) to output, further based on information about a retailer associated with the online concierge system 140 that is related to the current session, the score for the user indicative of the predicted type of the user for the current session and for the retailer.

In one or more embodiments, the online concierge system 140 retrieves (e.g., via the user type prediction module 260), from a database of the online concierge system 140 (e.g., the data store 240), data with information about at least one of: a ratio between a number of unique items the user converted during a defined time period by directly adding the unique items to shopping carts without further engagement with the unique items and a total number of items the user converted during the defined time period, or an average shopping time per unique item converted by the user during the defined time period. The online concierge system 140 may then apply the user type prediction model (e.g., via the user type prediction module 260) to output, further based on the retrieved data, the score for the user.

The online concierge system 140 compares 620 (e.g., via the content priority module 280) the score for the user with a threshold score. Responsive to the score for the user being greater than the threshold score, the online concierge system 140 identifies 625 (e.g., via the content priority module 280), based at least in part on the score for the user, user data associated with the user, and information about the current session, a set of user interface elements (e.g., set of items) arranged in a specific order for presentation to the user.

The online concierge system 140 may rank (e.g., via the content priority module 280), based at least in part on the score for the user, the user data, and the information about the current session, a plurality of user interface elements retrieved from a database of the online concierge system 140 (e.g., the data store 240) to identify a rank of each user interface element of the plurality of user interface elements. In one or more embodiments, to rank the plurality of user interface elements, the online concierge system 140 accesses a content priority model of the online concierge system 140 (e.g., via the content priority module 280), wherein the content priority model is trained to identify a priority of a user interface element for presentation to the user. In such cases, the online concierge system 140 may apply the content priority model (e.g., via the content priority module 280) to output, based at least in part on the score for the user, the user data, and the information about the current session, the rank for each user interface element of the plurality of user interface elements that is indicative of a priority of that user interface element for presentation to the user. The online concierge system 140 may select (e.g., via the content priority module 280), based on the rank of each user interface element, a defined number of user interface elements from the plurality of user interface elements as the set of user interface elements for presentation to the user. The online concierge system 140 may arrange (e.g., via the content priority module 280), based on the rank of each user interface element, the set of user interface elements in the specific order.

The online concierge system 140 may retrieve (e.g., via the content priority module 280), from the database, the user data with information about at least one of a plurality of user interface elements associated with a plurality of items converted by the user during each order of a plurality of orders for a defined time period, or affinities for the defined time period between a plurality of categories of user interface elements. In one or more embodiments, the online concierge system 140 receives (e.g., at the content priority module 280), from the device associated with the user and via the network, the information about the current session including at least one of content of a cart associated with the current session or a browsing history of the user for the current session. In one or more other embodiments, the online concierge system 140 gathers, via the one or more sensors mounted to the physical receptacle utilized by the user during the current session for shopping at the location of the retailer, information about physical locations of the physical receptacle during the current session. The online concierge system 140 may then receive (e.g., at the communication module 270), from a computing system associated with the physical receptacle and via the network, the gathered information as at least a portion of the information about the current session.

The online concierge system 140 generates 630 (e.g., via the content priority module 280) a user interface of the device associated with the user (e.g., a user interface of the user client device 100 or user interface at the dashboard 315 of the smart shopping cart 150) that includes the set of user interface elements arranged according to the specific order. The online concierge system 140 causes 635 (e.g., via the content presentation module 210) the device associated with the user to display the user interface with the set of user interface elements arranged according to the specific order.

The online concierge system 140 may gather (e.g., via the machine-learning training module 130), over a defined time period, data related to interactions between a collection of users of the online concierge system 140 and the online concierge system 140. The online concierge system 140 may assign (e.g., via the machine-learning training module 130), based on the gathered data, a label to each user in the collection of users. The online concierge system 140 may train (e.g., via the machine-learning training module 130), using the gathered data and the assigned label for each user in the collection of users, the user type prediction model to generate a set of initial values for a set of parameters of the user type prediction model. The online concierge system 140 may further collect (e.g., via the machine-learning training module 130) feedback data with information about engagement by the user with the set of user interface elements. The online concierge system 140 may re-train the user type prediction model by updating (e.g., via the machine-learning training module 130), using the collected feedback data, a set of parameters of the user type prediction model.

Embodiments of the present disclosure are directed to the online concierge system 140 that uses a trained model to predict whether a user of the online concierge system is a “browser”. During a session, a user expresses an intent for a specific item or items (e.g., shopping list or search query). Based on whether the user is a “browser” as predicted by the trained model, the online concierge system 140 can generate an appropriately personalized user interface to show content that is selected for a reason other than being directly responsive to one of these express intents.

ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, from a device associated with a user of an online system and via a network, session data related to a current session of the user with the online system;
accessing a user type prediction model of the online system, wherein the user type prediction model is trained to predict a type of the user for the current session;
applying the user type prediction model to output, based at least in part on the session data, a score for the user indicative of the predicted type of the user for the current session;
comparing the score for the user with a threshold score;
responsive to the score for the user being greater than the threshold score, identifying, based at least in part on the score for the user, user data associated with the user, and information about the current session, a set of user interface elements arranged in a specific order for presentation to the user;
generating a user interface of the device associated with the user that includes the set of user interface elements arranged according to the specific order; and
causing the device associated with the user to display the user interface with the set of user interface elements arranged according to the specific order.

2. The method of claim 1, wherein receiving the session data comprises:
receiving, via the device associated with the user and via the network, at least one of a search query entered by the user via a search interface of the device associated with the user, a number of predefined collections of items the user engaged with during the current session, a ratio between a number of unique first items the user engaged with during the current session and a total number of unique items the user added to a cart during the current session, a ratio between a number of unique second items added to the cart without the user viewing details associated with the second items and the total number of unique items added to the cart, or a timestamp of each unique item added to the cart.

3. The method of claim 1, wherein receiving the session data comprises:
gathering, via one or more sensors mounted to a physical receptacle utilized by the user during the current session for shopping at a location of a retailer associated with the online system, data with information about at least one of a duration of the current session at the location of the retailer, a number of items scanned by a computing system associated with the physical receptacle during the current session, an average speed of movement of the physical receptacle during the current session, or an average distance traveled by the physical receptacle during the current session per item added to the physical receptacle; and
receiving, from the computing system associated with the physical receptacle and via the network, the gathered data as at least a portion of the session data.

4. The method of claim 1, further comprising:
retrieving, from a database of the online system, data with information about at least one of a ratio between a number of unique items the user converted during a defined time period by directly adding the unique items to shopping carts without further engagement with the unique items and a total number of items the user converted during the defined time period, or an average shopping time per unique item converted by the user during the defined time period; and
applying the user type prediction model to output, further based on the retrieved data, the score for the user.

5. The method of claim 1, wherein applying the user type prediction model comprises:
applying the user type prediction model to output, further based on information about a retailer associated with the online system that is related to the current session, the score for the user indicative of the predicted type of the user for the current session and for the retailer.

6. The method of claim 1, further comprising:
gathering, over a defined time period, data related to interactions between a collection of users of the online system and the online system;
assigning, based on the gathered data, a label to each user in the collection of users; and
training, using the gathered data and the assigned label for each user in the collection of users, the user type prediction model to generate a set of initial values for a set of parameters of the user type prediction model.

7. The method of claim 1, further comprising:
collecting feedback data with information about engagement by the user with the set of user interface elements; and
re-training the user type prediction model by updating, using the collected feedback data, a set of parameters of the user type prediction model.

8. The method of claim 1, wherein identifying the set of user interface elements comprises:
ranking, based at least in part on the score for the user, the user data, and the information about the current session, a plurality of user interface elements retrieved from a database of the online system to identify a rank of each user interface element of the plurality of user interface elements;
selecting, based on the rank of each user interface element, a defined number of user interface elements from the plurality of user interface elements as the set of user interface elements for presentation to the user; and
arranging, based on the rank of each user interface element, the set of user interface elements in the specific order.

9. The method of claim 8, wherein ranking the plurality of user interface elements comprises:
accessing a content priority model of the online system, wherein the content priority model is trained to identify a priority of a user interface element for presentation to the user; and
applying the content priority model to output, based at least in part on the score for the user, the user data, and the information about the current session, the rank for each user interface element of the plurality of user interface elements that is indicative of a priority of that user interface element for presentation to the user.

10. The method of claim 8, further comprising:
retrieving, from a database of the online system, the user data comprising information about at least one of a plurality of user interface elements associated with a plurality of items converted by the user during each order of a plurality of orders for a defined time period, or affinities for the defined time period between a plurality of categories of user interface elements.

11. The method of claim 8, further comprising:
receiving, from the device associated with the user and via the network, the information about the current session including at least one of content of a cart associated with the current session or a browsing history of the user for the current session.

12. The method of claim 8, further comprising:
gathering, via one or more sensors mounted to a physical receptacle utilized by the user during the current session for shopping at a location of a retailer associated with the online system, information about physical locations of the physical receptacle during the current session; and
receiving, from a computing system associated with the physical receptacle and via the network, the gathered information as at least a portion of the information about the current session.

13. A computer program product comprising a non-transitory computer readable storage medium having instructions encoded thereon that, when executed by a processor, cause the processor to perform steps comprising:
receiving, from a device associated with a user of an online system and via a network, session data related to a current session of the user with the online system;
accessing a user type prediction model of the online system, wherein the user type prediction model is trained to predict a type of the user for the current session;
applying the user type prediction model to output, based at least in part on the session data, a score for the user indicative of the predicted type of the user for the current session;
comparing the score for the user with a threshold score;
responsive to the score for the user being greater than the threshold score, identifying, based at least in part on the score for the user, user data associated with the user, and information about the current session, a set of user interface elements arranged in a specific order for presentation to the user;
generating a user interface of the device associated with the user that includes the set of user interface elements arranged according to the specific order; and
causing the device associated with the user to display the user interface with the set of user interface elements arranged according to the specific order.

14. The computer program product of claim 13, wherein the instructions further cause the processor to perform steps comprising:
receiving the session data by receiving, via the device associated with the user and via the network, at least one of a search query entered by the user via a search interface of the device associated with the user, a number of predefined collections of items the user engaged with during the current session, a ratio between a number of unique first items the user engaged with during the current session and a total number of unique items the user added to a cart during the current session, a ratio between a number of unique second items added to the cart without the user viewing details associated with the second items and the total number of unique items added to the cart, or a timestamp of each unique item added to the cart.

15. The computer program product of claim 13, wherein the instructions further cause the processor to perform steps comprising:
gathering, via one or more sensors mounted to a physical receptacle utilized by the user during the current session for shopping at a location of a retailer associated with the online system, data with information about at least one of a duration of the current session at the location of the retailer, a number of items scanned by a computing system associated with the physical receptacle during the current session, an average speed of movement of the physical receptacle during the current session, or an average distance traveled by the physical receptacle during the current session per item added to the physical receptacle; and
receiving, from the computing system associated with the physical receptacle and via the network, the gathered data as at least a portion of the session data.

16. The computer program product of claim 13, wherein the instructions further cause the processor to perform steps comprising:
retrieving, from a database of the online system, data with information about at least one of a ratio between a number of unique items the user converted during a defined time period by directly adding the unique items to shopping carts without further engagement with the unique items and a total number of items the user converted during the defined time period, or an average shopping time per unique item converted by the user during the defined time period; and
applying the user type prediction model to output, further based on the retrieved data, the score for the user.

17. The computer program product of claim 13, wherein the instructions further cause the processor to perform steps comprising:
gathering, over a defined time period, data related to interactions between a collection of users of the online system and the online system;
assigning, based on the gathered data, a label to each user in the collection of users;
training, using the gathered data and the assigned label for each user in the collection of users, the user type prediction model to generate a set of initial values for a set of parameters of the user type prediction model;
collecting feedback data with information about engagement by the user with the set of user interface elements; and
re-training the user type prediction model by updating, using the collected feedback data, the set of parameters of the user type prediction model.

18. The computer program product of claim 13, wherein the instructions further cause the processor to perform steps comprising:
ranking, based at least in part on the score for the user, the user data, and the information about the current session, a plurality of user interface elements retrieved from a database of the online system to identify a rank of each user interface element of the plurality of user interface elements;
selecting, based on the rank of each user interface element, a defined number of user interface elements from the plurality of user interface elements as the set of user interface elements for presentation to the user; and
arranging, based on the rank of each user interface element, the set of user interface elements in the specific order.

19. The computer program product of claim 18, wherein the instructions further cause the processor to perform steps comprising:
retrieving, from a database of the online system, the user data comprising information about at least one of a plurality of user interface elements associated with a plurality of items converted by the user during each order of a plurality of orders for a defined time period, or affinities for the defined time period between a plurality of categories of user interface elements; and
receiving, from the device associated with the user and via the network, the information about the current session including at least one of content of a cart associated with the current session or a browsing history of the user for the current session.

20. A computer system comprising:
a processor; and
a non-transitory computer-readable storage medium having instructions that, when executed by the processor, cause the computer system to perform steps comprising:
receiving, from a device associated with a user of an online system and via a network, session data related to a current session of the user with the online system;
accessing a user type prediction model of the online system, wherein the user type prediction model is trained to predict a type of the user for the current session;
applying the user type prediction model to output, based at least in part on the session data, a score for the user indicative of the predicted type of the user for the current session;
comparing the score for the user with a threshold score;
responsive to the score for the user being greater than the threshold score, identifying, based at least in part on the score for the user, user data associated with the user, and information about the current session, a set of user interface elements arranged in a specific order for presentation to the user;
generating a user interface of the device associated with the user that includes the set of user interface elements arranged according to the specific order; and
causing the device associated with the user to display the user interface with the set of user interface elements arranged according to the specific order.
